(19) United States
(12) Patent Application Publication
(10) Pub. No.: US 2021/0023953 A1
(43) Pub. Date: Jan. 28, 2021

(54) CHARGING SYSTEM

(71) Applicant: TOYOTA JIDOSHA KABUSHIKI KAISHA, Toyota-shi (JP)

(72) Inventors: Ikuo OHTA, Toyota-shi (JP); Hideshi MIZUTANI, Toyota-shi (JP); Atsushi SAJIKI, Okazaki-shi (JP); Takao INATA, Setagaya-ku (JP); Yohei TANIGAWA, Toyota-shi (JP); Atsushi NAKAJIMA, Kariya-city (JP); Atsuo KOMATSUBARA, Nagakute-shi (JP)

(21) Appl. No.: 16/932,966

(22) Filed: Jul. 20, 2020

(30) Foreign Application Priority Data
Jul. 26, 2019 (JP) 2019-137821

(51) Int. Cl. B60L 53/12; H02J 50/10; H02J 50/40

(52) U.S. Cl. CPC B60L 53/12; H02J 50/40; H02J 50/10

(57) ABSTRACT

A charging system according to the present disclosure is a charging system for charging a battery of a vehicle including a power reception unit configured to be able to receive power in a non-contact manner and a battery charged by the power received by the power reception unit. The charging system according to the present disclosure includes: a charging apparatus including a plurality of power feed units that are arranged along a predetermined route, each of the power feed unit being configured to be able to feed electric power to the power reception unit in a non-contact manner; a detection unit configured to detect a current position of the vehicle; and a charging control unit configured to feed electric power from the power feed unit to the power reception unit in a non-contact manner based on the current position of the vehicle detected by the detection unit.

### CROSS REFERENCE TO RELATED APPLICATIONS

This application is based upon and claims the benefit of priority from Japanese patent application No. 2019-137821, filed on Jul. 26, 2019, the disclosure of which is incorporated herein in its entirety by reference.

### BACKGROUND

The present disclosure relates to a charging system.

In recent years, airports have been studying techniques for improving the work efficiency in work using a vehicle (e.g., conveying cargo).

For example, Japanese Unexamined Patent Application Publication No. 2002-321699 discloses a technique related to a tow vehicle that conveys cargo by traveling by itself along a guide line that connects a cargo depot to an aircraft parking area.

### SUMMARY

However, the technique disclosed in Japanese Unexamined Patent Application Publication No. 2002-321699 does not enable the tow vehicle to travel by itself while charging energy and therefore the work efficiency needs to be further improved.

Further, in recent years, airports have been considering switching vehicles working at the airports to electric automobiles including batteries mounted thereon in order to reduce greenhouse gas emissions.

Therefore, in the future, it is expected that the demand for improving the work efficiency of work using a vehicle including a battery thereon will increase.

The present disclosure has been made in view of the aforementioned circumstances and an object thereof is to provide a charging system capable of further improving the work efficiency of work using a vehicle including a battery mounted thereon.

A first exemplary aspect is a charging system for charging a battery of a vehicle including a power reception unit configured to be able to receive power in a non-contact manner and a battery charged by the power received by the power reception unit, the charging system including:

a charging apparatus including a plurality of power feed units that are arranged along a predetermined route, each of the power feed unit being configured to be able to feed electric power to the power reception unit in a non-contact manner;

a detection unit configured to detect a current position of the vehicle; and

a charging control unit configured to feed electric power from the power feed unit to the power reception unit in a non-contact manner based on the current position of the vehicle detected by the detection unit.

According to the above-described present disclosure, it is possible to provide a charging system capable of further improving the work efficiency of work using a vehicle including a battery mounted thereon.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a diagram showing an example of an appearance configuration of a charging system according to an embodiment;

FIG. 2 shows an example of an arrangement of power feed units according to the embodiment;

FIG. 3 shows another example of an arrangement of the power feed units according to the embodiment;

FIG. 4 is a block diagram showing an example of a block configuration of the charging system according to the embodiment; and

FIG. 5 is a flowchart showing an example of a flow of processing performed by the charging system according to the embodiment while a vehicle is traveling.

### DESCRIPTION OF EMBODIMENTS

Hereinafter, although the present disclosure will be described with reference to an embodiment of the present disclosure, the present disclosure according to claims is not limited to the following embodiment. Moreover, all the components described in the following embodiment are not necessarily essential for means for solving problems. For the clarification of the description, the following description and the drawings may be omitted or simplified as appropriate. Throughout the drawings, the same components are denoted by the same reference signs and repeated descriptions will be omitted as appropriate.

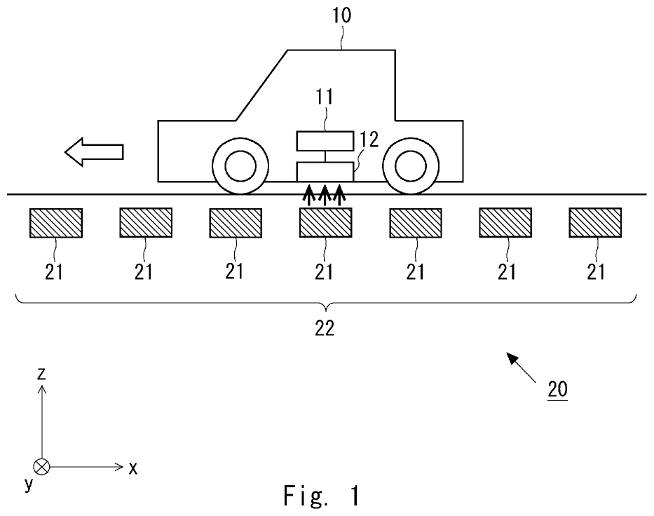

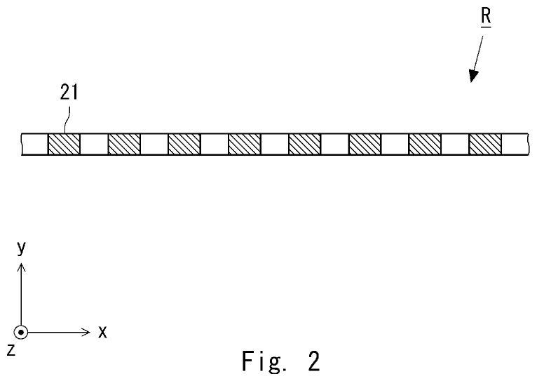

First, an appearance configuration of a charging system 20 according to this embodiment is described with reference to FIGS. 1 and 2. FIG. 1 is a side view showing an example of the appearance configuration of the charging system 20 according to this embodiment, and FIG. 2 is a top view showing an example of an arrangement of power feed units 21 according to this embodiment.

As shown in FIG. 1, the charging system 20 according to this embodiment is a system for charging a battery 11 of a vehicle 10.

To be specific, the vehicle 10 includes, in addition to the battery 11, a power reception unit 12 capable of receiving power in a non-contact manner, and the battery 11 is charged by the power received by the power reception unit 12.

Note that the vehicle 10 may be any vehicle including the battery 11 and the power reception unit 12. For example, the vehicle 10 may be an electric vehicle (EV), a plug-in hybrid vehicle (PHV), a plug-in fuel cell vehicle (plug-in FCV), or the like.

In this embodiment, it is assumed that the vehicle 10 is a work vehicle that works at an airport. Specifically, the vehicle 10 is a work vehicle such as a cargo truck that conveys cargo, a tug vehicle that conveys a container loaded with cargo or the like, or a forklift that conveys a pallet loaded with cargo or the like, but the vehicle 10 is not limited to these.

The charging system 20 according to this embodiment includes a charging apparatus 22 including a plurality of power feed units 21.

As shown in FIGS. 1 and 2, the plurality of power feed units 21 are arranged along a route R, and each of the power feed units 21 can feed electric power to the power reception unit 12 of the vehicle 10 in a non-contact manner. In FIG. 1, it is shown that the power feed units 21 are buried in the ground, but this configuration is merely an example. For example, the power feed units 21 may be installed on a road surface.

In this embodiment, it is assumed that a power feed system that feeds electric power from the power feed unit 21 to the power reception unit 12 is an electromagnetic induction system. When the electromagnetic induction system is employed, the power feed unit 21 and the power reception unit 12 are configured by coils. At this time, the coil is disposed so that the axial direction of the coil substantially coincides with a direction perpendicular to the ground. When an electric current is passed through the coil configuring the power feed unit 21, a magnetic flux is generated in the direction perpendicular to the ground. When the power reception unit 12 moves to the same position (which is, more specifically, a position where the magnetic flux generated by the power feed unit 21 can pass through the inside of the coil configuring the power reception unit 12, the same applying hereinafter.) as that of the power feed unit 21, a dielectric current is passed through the coil configuring the power reception unit 12 by the magnetic flux. In this way, electric power is fed from the power feed unit 21 to the power reception unit 12.

Therefore, while the vehicle 10 is traveling on the route R, the operation of feeding electric power from the power feed unit 21 located at the same position as that of the power reception unit 12 to the power reception unit 12 is repeated. By doing so, the power reception unit 12 of the vehicle 10 traveling along the route R receives electric power, so that the battery 11 is charged.

An example of the route R in which a plurality of power feed units 21 are arranged is described below.

In the case of the vehicle 10 working at the airport, work contents at the airport are predetermined. Therefore, there is a predetermined route among the routes along which the vehicle 10 travels during work at the airport. For example, if the vehicle 10 is a tug vehicle or the like, the route connecting a cargo depot to an aircraft parking area is the predetermined route along which the vehicle 10 always travels during work at the airport. Further, if the vehicle 10 can travel by itself, the vehicle 10 can travel by itself on the predetermined route without an operator driving the vehicle 10.

Therefore, the route R on which the plurality of power feed units 21 are arranged is set to be the predetermined route along which the vehicle 10 travels during work at the airport. By doing so, the battery 11 can be charged while the vehicle 10 is working at the airport. Further, if the vehicle 10 can travel by itself, the route R may be the predetermined route along which the vehicle 10 travels by itself during work at the airport. As a result, the battery 11 can be charged while the vehicle 10 is working by self-propelled driving at the airport.

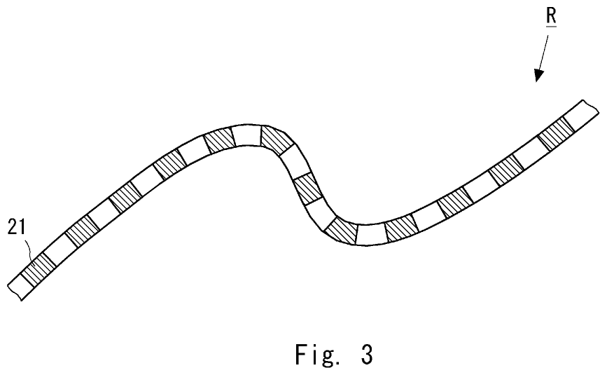

Note that although FIG. 2 shows an example in which the route R is linear, the shape of it is not limited thereto. The route R may be curved, for example, as shown in FIG. 3. Further, the route R may be a combination of a linear part as shown in FIG. 2 and a curved part as shown in FIG. 3.

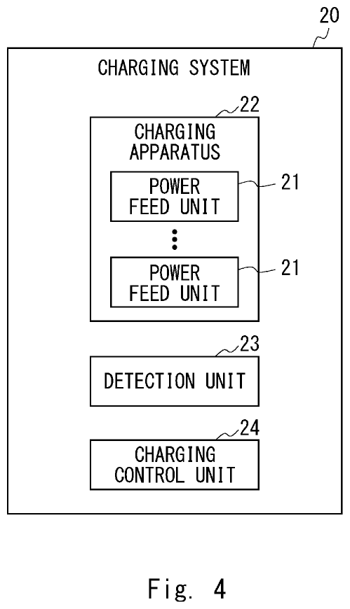

Next, a block configuration of the charging system 20 according to this embodiment is described with reference to FIG. 4. FIG. 4 is a block diagram showing an example of the block configuration of the charging system 20 according to this embodiment.

As shown in FIG. 4, the charging system 20 according to this embodiment includes a detection unit 23 and a charging control unit 24 in addition to the above-described charging apparatus 22.

The detection unit 23 detects the current position of the vehicle 10. For example, if the vehicle 10 has a Global Positioning System (GPS) function, the detection unit 23 may acquire the current position of the vehicle 10 measured (i.e., calculated) by the vehicle 10 using the GPS function. Further, in the case of the vehicle 10 working at the airport, a work plan including work contents, working time, and the like at the airport is predetermined. Therefore, the detection unit 23 may predict the current position of the vehicle 10 based on the work plan of the vehicle 10.

The charging control unit 24 feeds electric power from the power feed unit 21 to the power reception unit 12 in a non-contact manner based on the current position of the vehicle 10 detected by the detection unit 23. Specifically, the charging control unit 24 selects any one of the plurality of power feed units 21 based on the current position of the vehicle 10, and feeds electric power from the selected power feed unit 21 to the power reception unit 12 in a non-contact manner. For example, the charging control unit 24 holds position information of the position where each of the plurality of power feed units 21 is arranged and selects the power feed units 21 located within a first predetermined distance from the current position of the vehicle 10. However, as the vehicle 10 has already passed through the power feed units 21 located in the direction opposite to the direction in which the vehicle 10 travels, it is not necessary to select many of them. Therefore, the charging control unit 24 may determine the direction in which the vehicle 10 travels from the history of the positions of the vehicle 10, and select, in regard to the power feed units 21 located in the direction opposite to the direction in which the vehicle 10 travels, the power feed unit 21 located within a second predetermined distance, which is shorter than the first predetermined distance, from the current position.

As described above, when the electromagnetic induction system is employed, only the power fed from the power feed unit 21 located at the same position as that of the power reception unit 12 is received by the power reception unit 12. In other words, even when electric power is fed from the power feed unit 21 which is not located at the same position as that of the power reception unit 12, the electric power is not received by the power reception unit 12 and thus it is wasted.

In this embodiment, the charging control unit 24 feeds electric power to the power reception unit 12 in a non-contact manner only from the power feed unit 21 selected based on the current position of the vehicle 10. Thus, it is possible to prevent wasted power consumption and save energy.

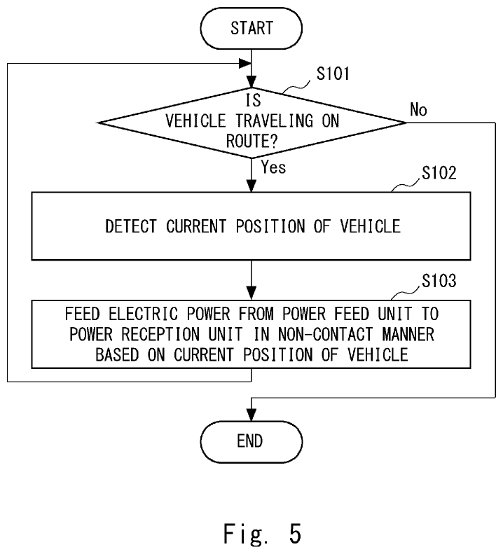

Next, a flow of processing performed by the charging system 20 according to this embodiment while the vehicle 10 is traveling is described with reference to FIG. 5. FIG. 5 is a flowchart showing an example of the flow of the processing performed by the charging system 20 according to this embodiment while the vehicle 10 is traveling.

As shown in FIG. 5, first, the charging control unit 24 determines whether the vehicle 10 is traveling on a route S (Step S101). For example, the charging control unit 24 may hold position information of each of the plurality of power feed units 21, and if the current position of the vehicle 10 detected by the detection unit 23 is within a third predetermined distance from any of the plurality of power feed units 21, the charging control unit 24 may determine that the vehicle 10 is traveling on the route S. Alternatively, the charging control unit 24 may determine whether the vehicle 10 is traveling on the route S based on the work plan including the work contents, the working time, and the like of the vehicle 10 at the airport.

If the vehicle 10 is not traveling on the route S (No in Step S101), the process ends.

On the other hand, if the vehicle 10 is traveling on the route S (Yes in Step S101), the detection unit 23 first detects the current position of the vehicle 10 (Step S102). Next, the charging control unit 24 feeds electric power from the power feed unit 21 to the power reception unit 12 in a non-contact manner based on the current position of the vehicle 10 detected by the detection unit 23 (Step S103). After that, the process returns to the process in Step S101. That is, while the vehicle 10 is traveling on the route S, the processes in Steps S102 and S103 are repeated.

Next, an effect of the charging system 20 according to this embodiment is described.

In the charging system 20 according to this embodiment, a plurality of power feed units 21 are arranged along the predetermined route S, the current position of the vehicle 10 is detected, and then electric power is fed from the power feed unit 21 to the power reception unit 12 of the vehicle 10 in a non-contact manner based on the detected current position of the vehicle 10.

This configuration makes it possible to feed electric power to the power reception unit 12 of the vehicle 10 in a non-contact manner and charge the battery 11 of the vehicle 10 while the vehicle 10 is traveling on the route S. Accordingly, it is possible to further improve the work efficiency of work using the vehicle 10 since the vehicle 10 can travel while the battery 11 is being charged.

Further, the charging system 20 selects the power feed unit 21 from among the plurality of power feed units 21 based on the current position of the vehicle 10, and feeds electric power from the selected power feed unit 21 to the power reception unit 12 of the vehicle 10 in a non-contact manner.

By this configuration, even if electric power is fed to the power reception unit 12, electric power is not fed to the power reception unit 12 from the power feed unit 21 of which the power cannot be received by the power reception unit 12, so that it is possible to prevent wasted power consumption and save energy.

Note that the present disclosure is not limited to the above-described embodiment and can be modified as appropriate without departing from the spirit of the present disclosure.

For example, in the aforementioned embodiment, although the vehicle 10 has been described as being a work vehicle working at an airport, it is not limited to a work vehicle. The vehicle 10 may be any vehicle as long as it travels on a predetermined route (the route S in the aforementioned embodiment).

Further, although the power feed system that feeds electric power from the power feed unit 21 to the power reception unit 12 has been described as being an electromagnetic induction system in the aforementioned embodiment, it is merely an example. The power feed system may be any system that feeds electric power from the power feed unit 21 to the power reception unit 12 in a non-contact manner.

Further, in the aforementioned embodiment, the charging system according to the present disclosure has been described as a hardware configuration, but the present disclose is not limited thereto. In the present disclosure, any processing of the charging system can be achieved by a processor, such as a CPU (Central Processing Unit), loading and executing a computer program stored in a memory.

The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A charging system for charging a battery of a vehicle comprising a power reception unit configured to be able to receive power in a non-contact manner and a battery charged by the power received by the power reception unit, the charging system comprising:
a charging apparatus comprising a plurality of power feed units that are arranged along a predetermined route, each of the power feed unit being configured to be able to feed electric power to the power reception unit in a non-contact manner;
a detection unit configured to detect a current position of the vehicle; and
a charging control unit configured to feed electric power from the power feed unit to the power reception unit in a non-contact manner based on the current position of the vehicle detected by the detection unit.

2. The charging system according to claim 1, wherein the charging control unit selects any one of the plurality of power feed units based on the current position of the vehicle detected by the detection unit, and feeds electric power from the selected power feed unit to the power reception unit in a non-contact manner.

3. The charging system according to claim 1, wherein the plurality of power feed units are buried in a ground.

4. The charging system according to claim 1, wherein
the vehicle is a work vehicle that works at an airport, and
the route is a route along which the work vehicle travels during work at the airport.

5. The charging system according to claim 1, wherein
the vehicle is a work vehicle that works at an airport and is capable of traveling by itself, and
the route is a route along which the work vehicle travels by itself during work at the airport.
